(19) United States
(12) Patent Application Publication
(10) Pub. No.: US 2016/0068315 A1
(43) Pub. Date: Mar. 10, 2016

(54) Auto-Alert Toothpaste Cap and Methods of Delivering an Audio Alert

(71) Applicant: John Karl Hintz, Hayden, ID (US)

(72) Inventor: John Karl Hintz, Hayden, ID (US)

(21) Appl. No.: 14/483,024

(22) Filed: Sep. 10, 2014

(51) Int. Cl. B65D 47/08; G08B 3/10; A61C 15/04; B65D 35/44; B65D 47/12

(52) U.S. Cl. CPC B65D 47/0842; B65D 35/44; B65D 47/122; A61C 15/043; G08B 3/10

(57) ABSTRACT

A toothpaste cap device including a bottom cap portion configured to be seated over a toothpaste tube by an internally threaded connector. The bottom cap portion has a toothpaste-dispensing nozzle disposed on an outside upper surface. The device includes an upper cap portion associated with a sound module containing an audio alert, the sound module being automatically activated to play the alert upon opening of the upper portion of the cap. The bottom cap portion can optionally comprise an enclosure cavity enclosing a removable floss spool. A method of delivering an audio alert including providing an auto-activated sound module within a toothpaste cap. The alert may be a recorded message regarding oral hygiene.

### TECHNICAL FIELD

The invention is related to auto-alert toothpaste caps that have a sound module to relay a voice-recorded message, combined with a toothpaste-dispensing cap for a container of toothpaste. Methods of delivering an alert regarding oral hygiene involve activation of the auto-alert aspects of the auto-alert cap.

### BACKGROUND OF THE INVENTION

Remembering to use dental floss along with brushing ones teeth for an appropriate amount of time is important for good dental hygiene. Often, flossing is overlooked or forgotten prior to brushing. Additionally, there is a tendency for insufficient time spent brushing. It would be advantageous to develop methods and devices to remind people to floss their teeth and/or brush for an appropriate amount of time.

### SUMMARY OF THE INVENTION

The invention encompasses toothpaste cap devices comprising an internal cavity within an upper cap portion with a light activated sound module within the internal cavity. The sound module contains a sound message regarding aspects of oral hygiene. A retainer plate is disposed below the sound module within the internal cavity. The retainer plate has an opening that passes light through the retainer plate to activate the sound module. A bottom cap portion of the device is connected to the top cap portion by a hinge region with the bottom cap portion being configured to attach the cap device to a toothpaste container.

In one aspect, the invention encompasses an auto-alert toothpaste cap including a bottom cap portion having an enclosure configured to be seated over a toothpaste tube with an internally threaded connector having internal treads for connecting the toothpaste cap onto an outwardly threaded nozzle of the toothpaste tube. A toothpaste-dispensing nozzle is disposed on an outside upper surface of the bottom cap portion and opposing the internally threaded connector. An upper cap portion containing a sound module containing a sound alert, where the sound module can be automatically activated to play the recorded message upon opening of the upper portion of the cap.

The invention further encompasses a method of delivering a reminder regarding oral hygiene. The method includes providing an auto-activated sound module within a toothpaste cap device, the device being activated upon opening of the device to play a sound alert or reminder regarding oral hygiene.

### BRIEF DESCRIPTION OF THE DRAWINGS

Preferred embodiments of the invention are described below with reference to the following accompanying drawings.

FIG. 1 illustrates a side view of one embodiment of the invention in conjunction with a toothpaste container.

FIG. 2 shows an alternate view of the embodiment of the invention illustrated in FIG. 1 having a cap device in an “open” position.

FIG. 3 illustrates a top view of the cap device depicted in FIG. 1.

FIG. 4 depicts a retainer portion of the cap device which is visible in FIG. 2.

FIG. 5 shows a cross-sectional view of the embodiment of the invention shown in FIG. 1 taken along line 5-5 of FIG. 1.

FIG. 6 shows the cross-sectional view of FIG. 5 having the cap device in an “open” position.

FIG. 7 illustrates a cross-sectional exploded view of the device as depicted in FIG. 5.

FIG. 8 illustrates a cross-sectional view of an alternative embodiment of the invention relative to that depicted in FIGS. 1-7.

FIG. 9 shows an exploded view of the embodiment depicted in FIG. 8.

FIG. 10 shows alternative and additional aspects in another embodiment of the invention.

FIG. 11 shows an exploded view of the cross-section depicted in FIG. 10.

FIG. 12 shows an optional component that may be utilized to adapt the cap device to a particular toothpaste tube configuration.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

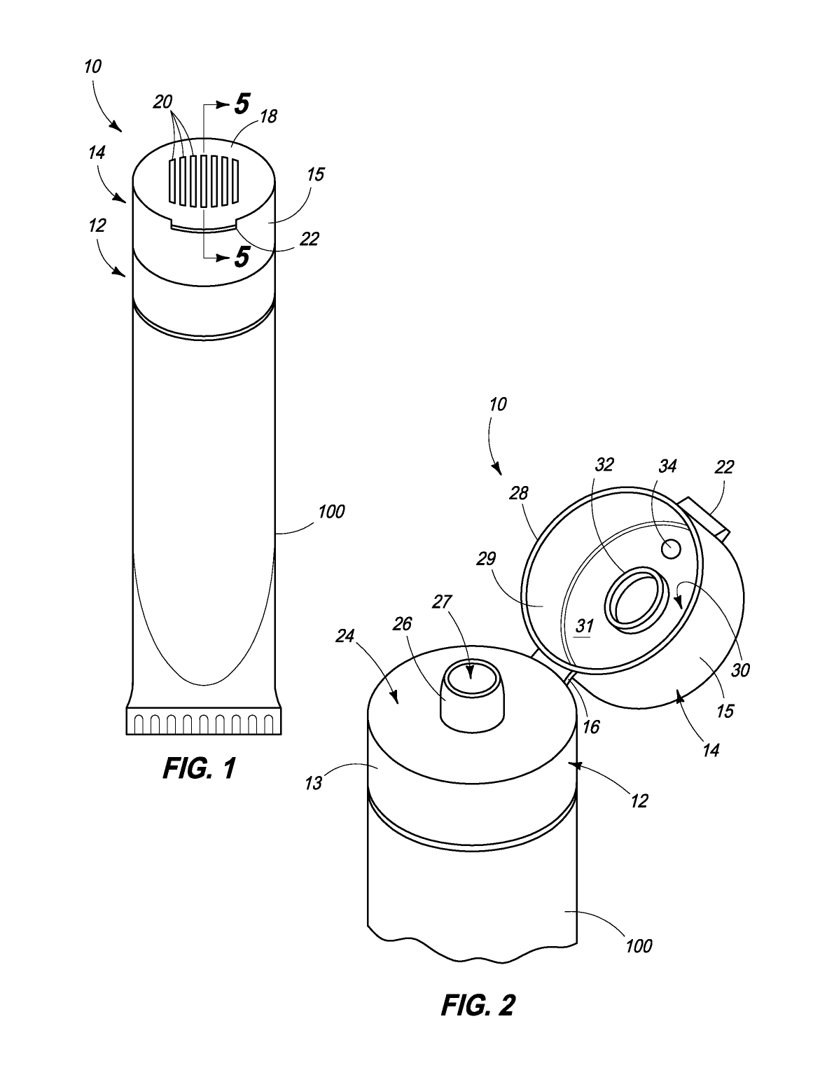

The invention pertains to toothpaste cap devices with auto-activated sound alerts. Embodiments of the invention are described generally with reference to FIGS. 1-12.

Referring initially to FIG. 1, such depicts a particular embodiment of the invention comprising an upper cap portion 14 and a lower cap portion 12. A hinge region 16 (FIG. 2) connects the upper cap portion with the bottom cap portion, the hinge region allowing the upper cap portion to close onto the bottom cap portion 12 as depicted in FIG. 1. The two portions 12, 14 of device 10 can be moved from a closed position (FIG. 1) to an opened position (FIG. 2) by manipulation (opening and closing) of hinge region 16.

Device 10 can comprise a single-piece structure that includes the bottom cap portion, the upper cap portion and the hinge region. The single piece configuration can be formed by, for example, injection molding utilizing, for instance, any moldable type plastic that remains flexible upon curing. In certain embodiments such as caps that are auto-activated by light, the cap material can preferably be opaque. Alternatively, an opaque coating can be applied after fabrication of the cap.

Device 10 can be configured seat onto a toothpaste container 100 and can be cylindrical in certain embodiments. The outer diameter of device 10 can be, for example, approximately 3.5 cm through 4.0 cm, however other sizes are contemplated. It is to be understood that although the invention is described and illustrated with respect to a tube type of toothpaste container, the invention contemplates alternative configurations of the cap device that can be utilized in conjunction with alternative container types. Accordingly, alternative shapes of device 10 are contemplated. Additionally, the overall height of device 10 and its upper and bottom portions are not limited to any particular values. An example overall height of device 10 can be about 2.75 cm or greater, with an example upper portion height of 1.5 cm and an example bottom portion height of 1.25 cm.

Still referring to FIG. 1, upper cap portion 14 can have a sidewall 15 and an upper surface 18 which can comprise a plurality of slits 20 that allow sound to pass from within the upper cap portion. An external tab 22 can be provided extending outward from sidewall 15 along an outer edge of upper surface 18 to allow ease of opening of the top cap portion using upward force on the tab.

Referring to FIG. 2, cap device 10 is illustrated in an open position. Bottom cap portion 12 has a sidewall 13 and an upper outer surface 24. A nozzle 26 can be centrally disposed relative to upper surface 24 and can extend upward from the upper surface. Nozzle 26 can be a toothpaste-dispensing nozzle having an internal passage 27 through the nozzle that aligns with a nozzle on a toothpaste tube (see below) to form a continuous passage through the toothpaste tube nozzle and the cap nozzle allowing toothpaste from the tube to be dispensed through cap device 10.

Upper cap portion 14 has an internal sidewall surface 29 and a lower surface 28 of the sidewall that contacts upper surface 24 of the lower portion to seal the cap in the closed position.

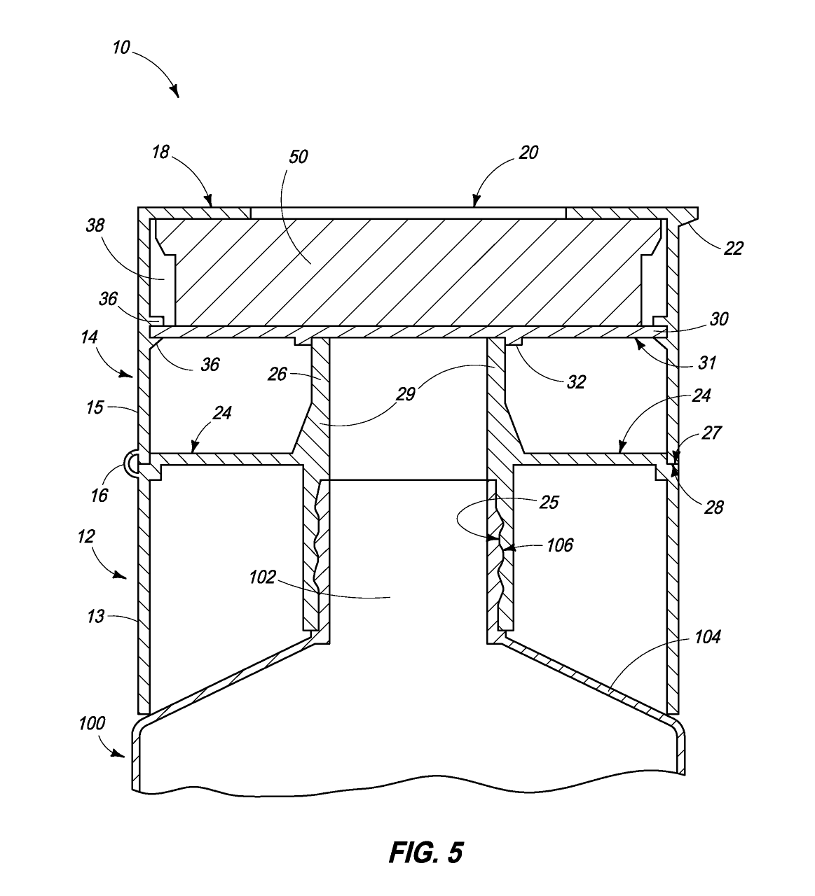

A retainer plate 30 is disposed within the upper cap portion such that a sound module cavity is created within the upper portion (see FIG. 5). Retainer plate 30 can comprise a lower surface 31 with a cylindrical ring protrusion 32 configured to contact or fit over an upper portion of dispensing nozzle 26 in the closed position. In particular aspects, the sound module can be auto-activated to sound an alert when exposed to light or sound. Accordingly an opening 34 can be provided through retainer plate 30 to allow sound or light to reach the sound module. A sticker can optionally be placed over the opening in the retainer plate to avoid accidental activation until removal of the sticker. In other aspects, the sound module can be triggered by vibration, motion, push-button or a slide mechanism.

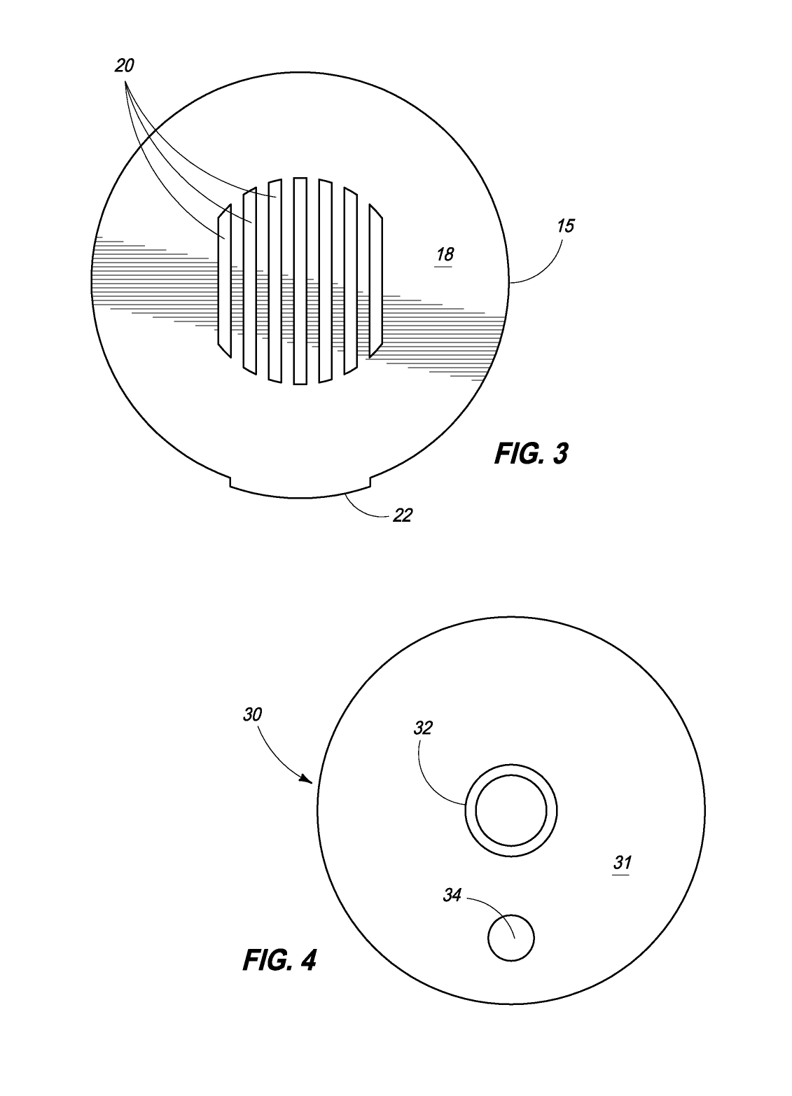

FIG. 3 depicts an example configuration of upper surface 18 of the upper cap portion having a plurality of slits 20 and tab 22 for opening of the cap device. The number and size of slits 20 are not limited to particular values. In alternative aspects, slits 20 can be replaced by a plurality of alternatively shaped openings such as squares, circular, rectangular or other shaped openings. In embodiments having slits that extend through the thickness of the cap, an optional disc shield (not shown) can be provided within the cap (between the top of upper portion 14 and an internal sound module, see FIG. 5) to protect the sound module from water. A lid structure can alternatively comprise slits 22 that extend only partially through the top of upper portion 14. In still another aspect, slits 20 can be eliminated and the top of upper cap portion 14 can be fabricated to be thin enough for sound to penetrate from within the cap when activated.

FIG. 4 depicts a bottom view of an example retention plate 30 having the sealing cylindrical protrusion 32 and a sound/light access opening 34. Although a single opening 34 is depicted, the invention contemplates use of a plurality of openings of various sizes and shapes.

With reference to FIG. 5, in particular aspects, bottom portion 12 of device 10 can thread onto a threaded nozzle 102 of toothpaste container 100. The cross-sectional view of FIG. 5 illustrates threads 25 of the bottom cap interlocked with external threads 106 of a connected toothpaste tube 100. When cap device 10 is mounted upon toothpaste container 100, a continuous pathway from container 100 through tube dispenser nozzle 102 and through cap dispenser nozzle 26 can be formed.

The cross-sectional view depicted in FIG. 5 is taken along line 5-5 of FIG. 1 and shows cap device 10 in the closed position such that a seal is formed between portions 12 and 14. In the shown configuration, the encircling lower sidewall surface 27 can be seated onto a ledge surface 28 built into the upper surface/sidewall area (junction of upper surface 24 and sidewall 13 of the lower portion. In the depicted embodiment, protruding ring 32 of retainer 30 fits over an uppermost portion of nozzle 26 to form a seal when the device is closed. Retainer plate 30 can be held in position by an internal circular groove created between upper and lower hubs 36 that encircle the inner sidewall surface of upper portion 14. The positioning of the retainer plate creates a cavity 38 for retaining a sound module 50 between the top of upper portion 14 and the retainer.

Sound module 50 is depicted within cavity 38. Sound module 50 is shown in an example shape. The shape and size of the sound module may depend upon the particular manufacturer. The speaker surface of the sound module is preferable disposed facing slits 20 of the upper cap portion. Sound module 50 can preferably be waterproof. As indicated above, sound module 50 can be auto-activate to emit an audio alert upon opening of the cap device. The sound module can be activated by any of the mechanisms discussed above.

The alert sound can comprise one or more recorded messages, music, various alert noises or any combination thereof. Where multiple alerts are utilized, the module can be configured to play them consecutively in a specific sequence or randomly. The alert can preferably be pre-recorded into the module by the module manufacturer or can be recorded by the distributor. In certain aspects, business customers may provide a pre-recorded alert or instructions for alert (s) that can be programmed into the module by the distributor. The sound module can be configured to discontinue the alert upon closing of the cap or can be configured to continue to play the alert until completion of the recording.

Lifetimes of various available sound modules vary. Frequency of use may affect the overall lifetime of the module. Upon expiration of the life of the module, the module can be replaced or, in some instance, a battery within the module may be replaced.

If the alert emitted by the sound module is a voice message, the message can preferably be a reminder regarding some aspect(s) of dental hygiene. Example messages can include, for example, a reminder to floss, a reminder to brush at least twice a day, a reminder to brush surfaces of braces, and/or a reminder to brush for at least two minutes. Other types of alerts, including gag messages or alerts sounds are contemplated. Example recording time capacity modules are available including but not limited to 10 seconds, 20 seconds, etc. Recordings can be as short as 6 seconds up to a minute or more.

One example sound module can be obtained from Shezhen ESYS Electronics Co., Ltd. The module can be, for example, No. ESYS-M-W1032, which is waterproofed and can be pre-recorded. It is to be understood that this particular sound module is but one example and that many alternate modules are available that may be utilized in conjunction with the present invention.

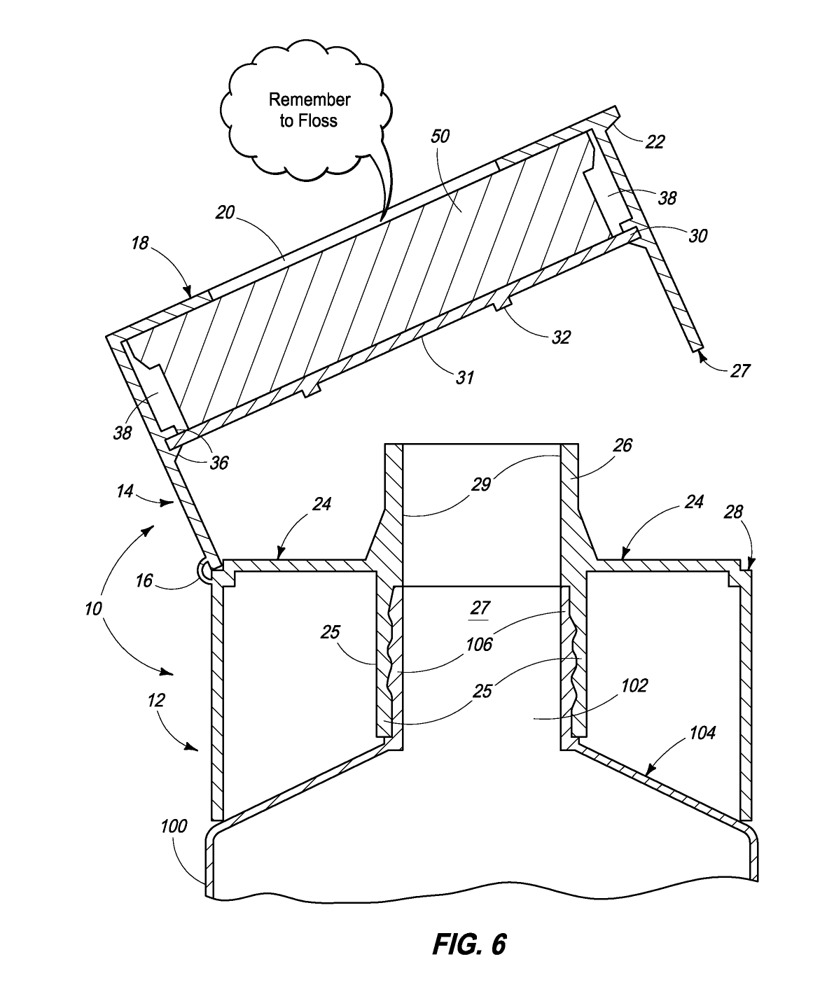

Referring next to FIG. 6, cap device 10 is depicted in cross-section in an open position. Such illustrates retention of sound module 50 within cavity. An example message is illustrated being emitted from sound module 50 through slit 20 in the top of the device. In this position, toothpaste may be dispensed from the tube through the bottom cap portion nozzle 26.

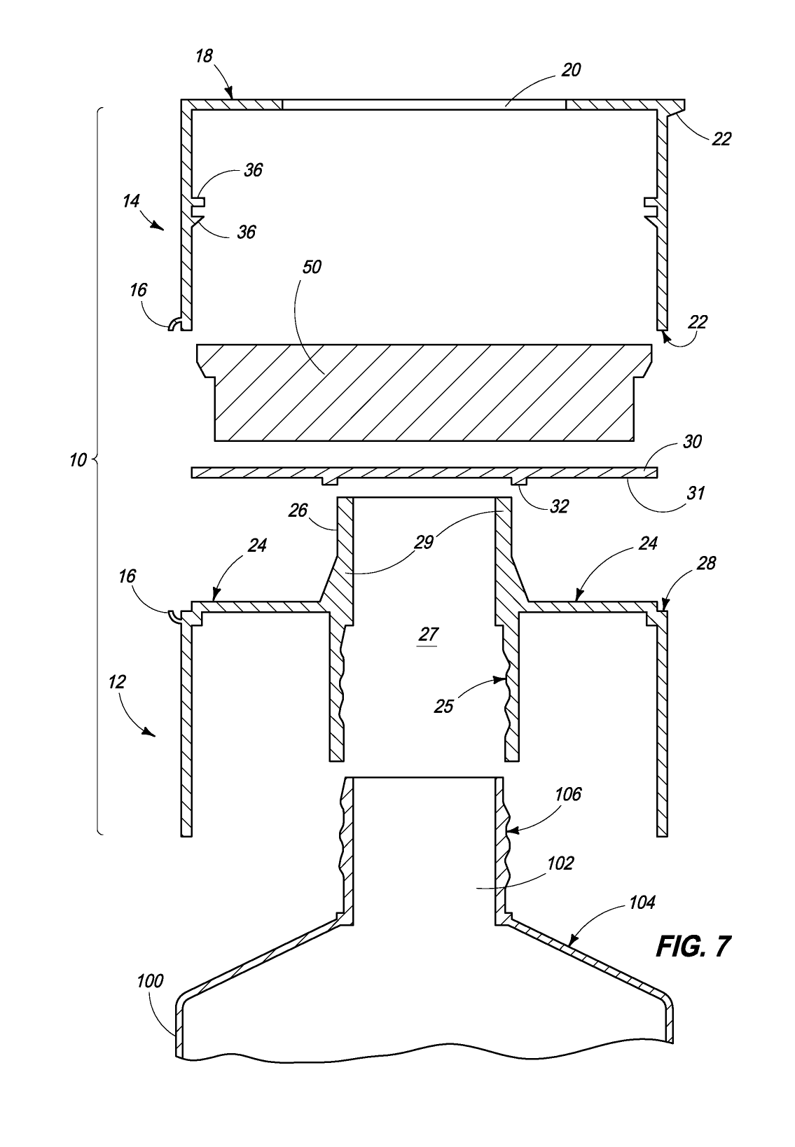

FIG. 7 depicts an exploded view of the cap device showing sound module 50 which can be removed and replaced within the upper portion of the cap by removal of retainer plate 30. As illustrated, opening 27 through nozzle 26 extends through the threaded adaptor on the bottom portion to create a continuous pathway through the bottom portion.

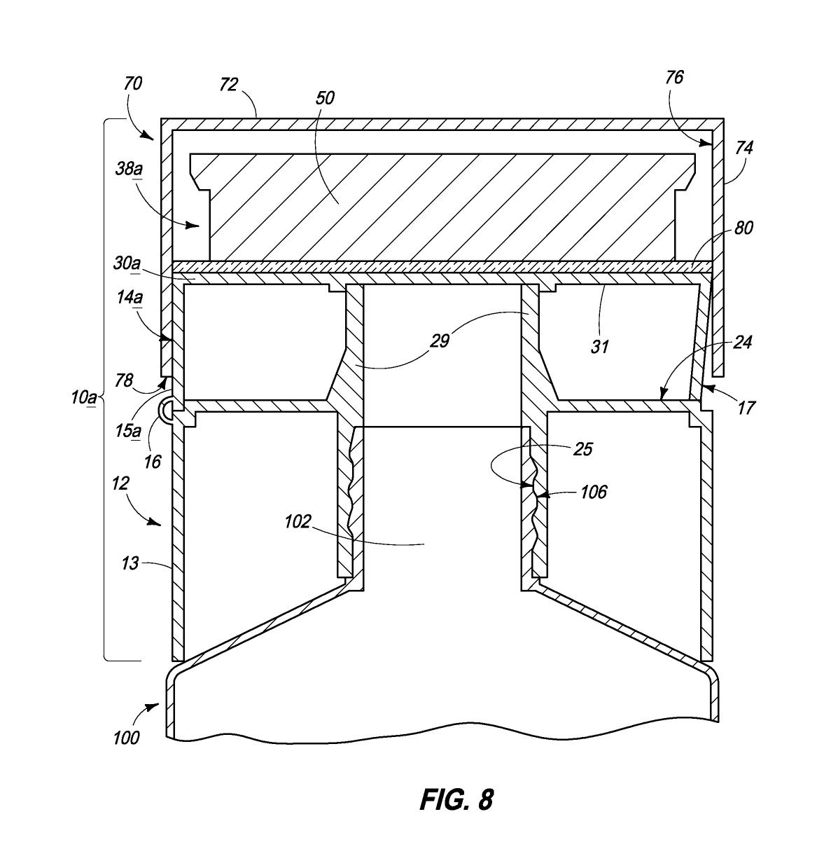

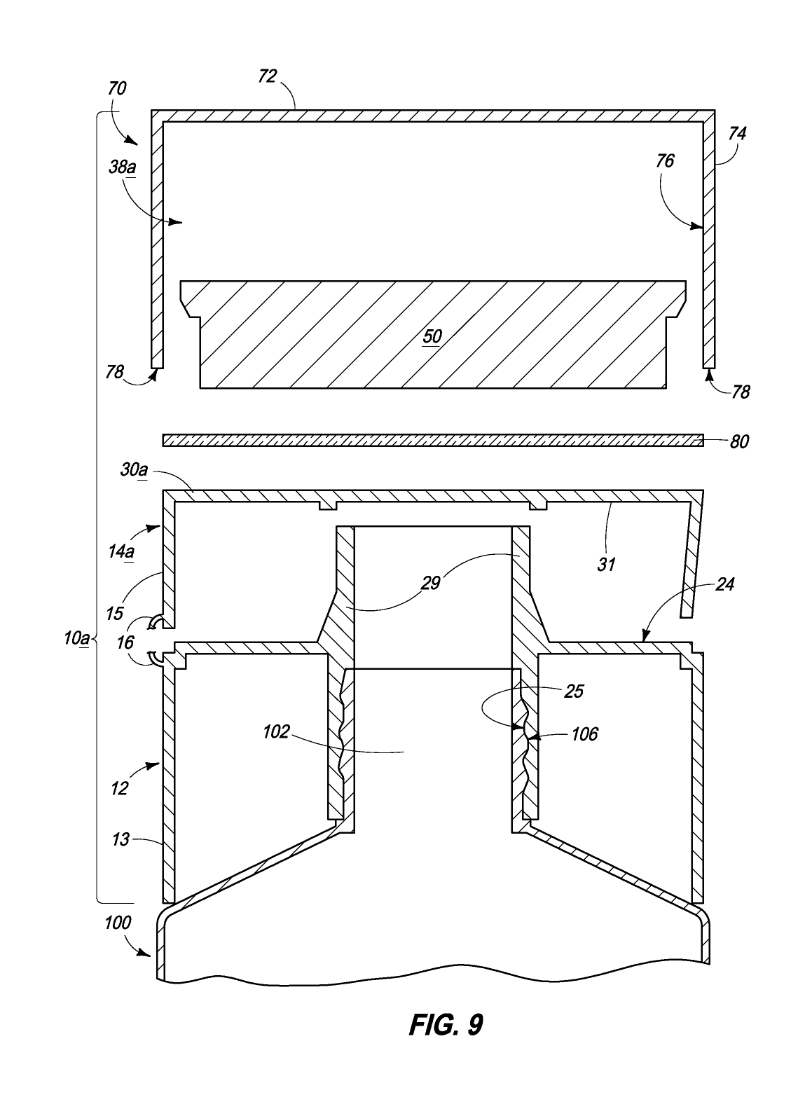

Another embodiment of the invention is described with reference to FIGS. 8-9. In this embodiment alternative aspects of the upper cap portion are combined with the lower cap portion described above. Feature of the cap device described earlier are labeled utilizing identical numeric identifiers as those used in FIGS. 1-7. New features are assigned unique numeric identifiers and modified features are assigned appendage “a”.

Referring to FIG. 8, an upper cap portion 14a of device 10 can be configured to comprise an integral retainer plate 30a. The retainer plate can comprise the features described above with respect to removable retainer plate 30. The integral retainer plate can be the top of the integral upper cap portion of the cap device. A separate lid portion 70 can be provided such that the inner sidewall surfaces 76 of sidewalls 74 of the lid portion can reversibly slide over the sidewalls of upper cap portion 14a. The lid can be held in place over the upper cap portion by friction fitting between sidewall surfaces 76 of the lid and the sidewalls 15a of upper cap portion 14a. The walls of the lid can extend to a position above hinge 16.

In the configuration depicted in FIG. 8-9, upper cap portion can have an angled surface 17 that opposes hinge 16. The angled surface can assist in opening of the top cap portion. Lid portion 70 can also comprise a flat or angled surface 74 that forms a friction fit with the angled surface of upper cap portion 14a.

An upper wall 72 of lid 70 can be uniform or can comprise any of the slit configurations discussed above.

When lid portion 70 is placed onto upper cap portion 14a, an enclosure 38a is created which can contain the sound module 50. The sound module can be any of the modules described above and can be activated accordingly. An optional protection plate 80 can be provided within enclosure 38a below the sound module. Such protection plate is preferable a transparent disc that allows light to pass through the retainer plate while providing protection of the sound module from moisture and contamination. Protection plate 80 can optionally be used in conjunction with the cap configurations described with respect to FIGS. 1-7.

FIG. 9 depicts an exploded view of the cap device illustrated in FIG. 8. As shown, lid portion 70 can be removed to replace the sound module or to change the batteries of the sound module. Protection plate 80 can be loose within the enclosure (38a of FIG. 8) or can be attached, for example by adhesive, to retainer plate 30a.

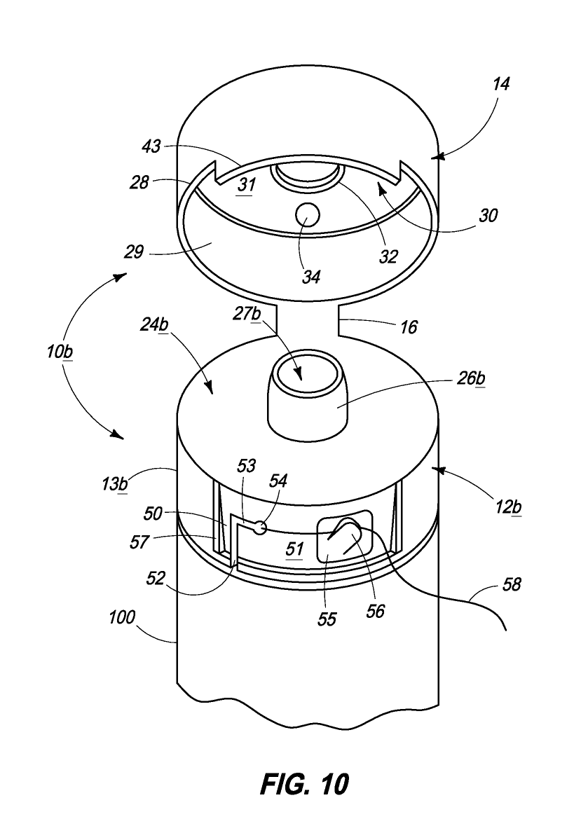

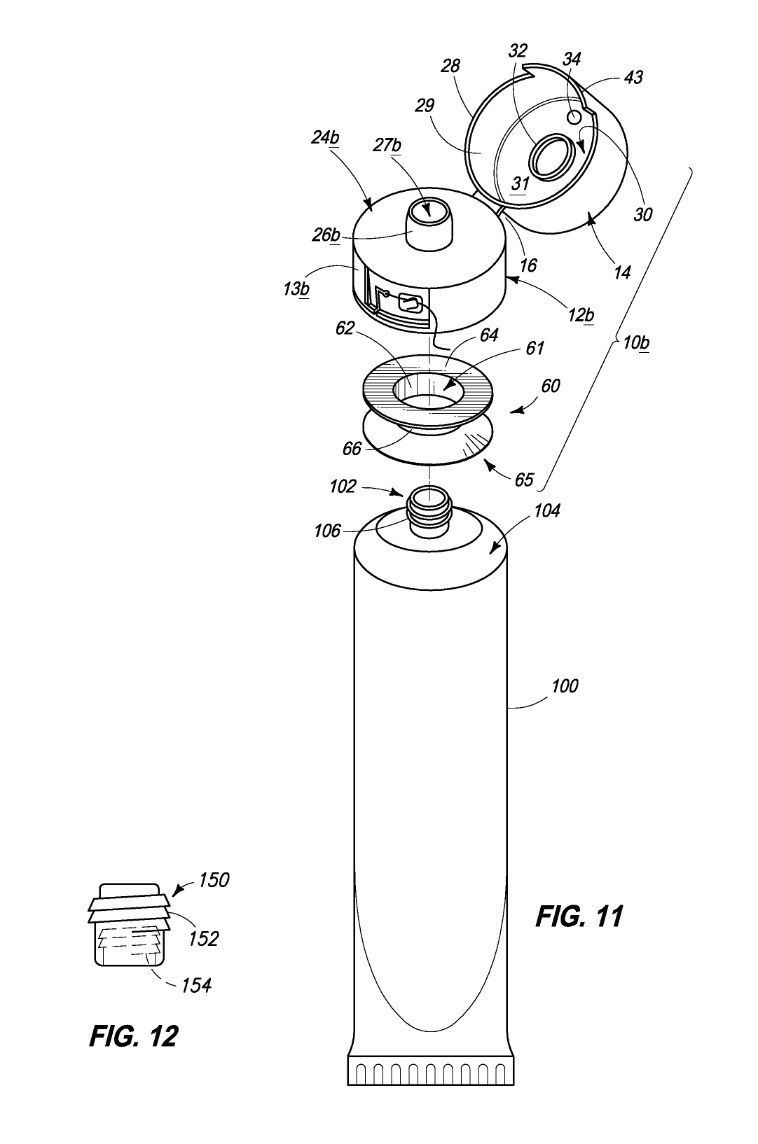

Other alternate embodiments of the invention are described with reference to FIGS. 10-11. In this embodiment, the upper portion of the cap device that houses a sound module can be combined with a lower portion that is configured to dispense dental floss. The floss-dispensing bottom cap portion is more fully described in patent application Ser. No. ______ (to be provided) that is filed simultaneously herewith and which is hereby incorporated by reference in its entirety.

With respect to FIGS. 10-11, features identical to those described above are numbered consistently with FIGS. 1-7. New features are assigned unique numeric identifiers and features similar to those described above are given the appending subscript “b”. Although the new features are illustrated in conjunction with the embodiments described with respect to FIGS. 1-7, these features can also be combined with any of the embodiments described above, including FIGS. 8-9.

As shown in FIG. 10, bottom cap portion 12b can comprise a floss-dispensing region 50 having a front surface portion 51 that in particular configurations can be angled relative to vertical sidewalls 13b of the bottom portion. A pair of raised vertical protrusions 57 can optionally be laterally spaced on either side of front surface 51 such that a seal may form between the raised protrusions and the upper cap portion when the device is in a closed position.

As illustrated, top cap portion 14 can comprise an extension tab 43 that extends below lower rim surface 28 and which can cover surface 51 in the closed position. In this embodiment a cavity area may be formed between the upper and bottom cap portions (not shown) surrounding front surface 51. It is to be understood that terms such as vertical, lateral, horizontal, etc. are used herein to describe relative aspects of the invention as depicted in the figures. Accordingly, the term “vertical” refers to the depictions and the relevant feature can become “non-vertical” if the actual device is tilted.

A floss-loading slit 52 can pass through the bottom cap sidewall, preferably within the front surface portion 51 as depicted in FIG. 10. Slit 52 can be a vertical slit extending vertically from a bottom edge of the bottom cap portion. A horizontal loading slit 53 can connect to vertical slit 52 and can culminate in an opening 54 for dispensing threaded floss. Dental floss 58 can be threaded from the inside of bottom cap portion 12b to the outside of bottom portion 12b through opening 54 by passing the floss initially through slits 52 and 53. The widths of slits 52 and 53 and the diameter of opening 54 are not limited to any particular values. Preferably these values will exceed the diameter of the dental floss being utilized to allow ease of loading through the slits and dispensing through the opening.

A floss cutter 55 can be mounted through front surface 51. Cutter 55 can comprise a raised blade 56 for cutting floss passed behind the blade. Accordingly, floss 58 can be passed from opening 54 behind blade 56 of cutter 55 and can be cut by the blade by applying pressure to the floss against the blade. Floss cutter 55 can comprise, for example, a metallic material that is bendable to allow blade 56 to be raised relative to the remaining surface of floss cutter 55.

Spacing between slit 52 and cutter 55 (center-to-center) is not limited to a particular value. The center-to-center distance can be, for example, greater than or equal to about 1.6 cm.

Tab 43 of the upper cap portion can have a width that is at least as wide as a width across the pair of raised protrusions 57 (outside edge to outside edge of the raised protrusions) of bottom cap portion 12b. Thus closing of cap device 10 can form a seal between tab 43 of upper cap portion 14 and bottom cap portion 12b to provide a sealed cavity across surface 51 of the bottom portion. The sealed cavity provides protection from contaminants of otherwise exposed floss 58. Tab 43 also covers blade 56 to protect against unintentional contact and potential injury that could occur if the blade were exposed during storage. Tab 43 can also be utilized to open the upper cap portion of device 10. Accordingly, feature 22 discussed above can be omitted or can be retained to assist in opening of the cap.

Referring next to FIG. 11, such shows an exploded view of the embodiment shown in FIG. 10. Floss cutter 55, slits 52 and 53 and opening 56 can preferably be disposed directly opposing the position of hinge region 16 on device 10.

FIG. 11 also illustrates a floss spool 60 that can be configured for removable insertion and retention within the bottom cap portion 12b. Spool 60 can be cylindrical as depicted and can have an interior surface 62 surrounding an internal opening 61. Spool 60 can have a planar upper disc 64 that can be spaced from an angled lower disc 65 by a cylinder portion 66. Spool 60 can be positioned within bottom portion 12b by sliding the internal opening 61 of the spool over an outer surface of the internally threaded connecter within the bottom cap portion. Attachment of device 10 onto toothpaste container 100 can form an enclosed space to retain floss spool 60 within an enclosure formed within the bottom cap portion.

Bottom disc 65 of the floss spool can preferably be angled downward relative to the cylinder to match an angle on an upper surface of a toothpaste tube. Such angled bottom disc can additionally allow a greater amount of floss to be loaded onto the spool (up to about 40 yards).

Referring to FIG. 12, an optional adaptor sleeve 150 can be provided where a non-standard toothpaste tube thread size is utilized in conjunction with any embodiment of device 10 discussed above. Adaptor sleeve 150 can comprise internal threads 154 that match the thread pattern of the toothpaste tube. External threads 152 can be provided to thread into threads 25 (see FIG. 7) of a connector of the bottom cap portion 12 (or 12b). Adaptor 150 can be fabricated of a moldable plastic material that can be the same as or can differ from the material comprised by device 10.

The disclosed configuration of device 10 represented in FIGS. 10-11 can allow simultaneous threading of floss through the loading slits and loading of the floss spool into the internal cavity of the bottom portion. Alternatively, floss can be threaded prior to loading of the spool. Once the spool has been loaded, dispensing device 10 can be mounted to a toothpaste tube by threading of the device onto the tube. The mounted device can contain the floss spool within the device with the tube forming a base of the enclosure. The floss is thereby hygienically protected from contamination.

The embodiments of the cap device of the invention can be provided in conjunction with a toothpaste container and/or can be provided independently of any toothpaste container. The floss spool can be provided together with the dispensing device and/or can be provided separately. It can be advantageous to provide an initial spool of floss together with the dispensing cap device and to additionally provide filled floss spools independently to allow refilling of the device after the initial (or subsequent) spools are depleted.

In particular aspects, cap device 10 can utilize the described floss dispensing aspects of the invention in conjunction with an alert message to remember to floss. Regardless, the alerts emitted by the devices encompassed by the invention can assist in achieving maximal results in dental hygiene by reminding the user to perform certain activities associated with oral health.

Methodology of the invention includes methods delivering an auto alert utilizing any of the cap device embodiments described above. Specifically, the methods include providing an auto-activated cap device comprising providing an auto-activated sound module within a toothpaste cap device, the device being activated upon opening of the device to play one or more audio alerts selected from the group consisting of reminder regarding oral hygiene, music, alert sounds, gag messages, custom messages and combinations thereof.

Activation of the cap device can comprise exposing the sound module to a stimulus including but not limited to light, sound, vibration, motion or touch mechanism. Alternatively, the sound module can be active manually or by a slide mechanism.

The method may additionally include providing a dual-purpose cap containing an enclosed floss spool that can deliver floss from within the device as set forth above.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A toothpaste cap comprising:
a bottom cap portion having an enclosure configured to be seated over a toothpaste tube;
an internally threaded connector within the enclosure, the connector having treads for connecting the toothpaste cap onto an outwardly threaded nozzle of the toothpaste tube;
a toothpaste dispensing nozzle disposed on an outside upper surface of the bottom cap portion and opposing the internally threaded connector; and
an upper cap portion containing a sound module comprising a an audio alert, the sound module being automatically activated to play the audio alert upon opening of the upper portion of the cap.

2. The cap of claim 1 wherein the sound module is auto-activated to play the audio alert by exposure to light when the upper cap portion is opened.

3. The cap of claim 2 further comprising a plurality of openings through a top of the upper cap portion.

4. The cap of claim 1 further comprising a retainer plate within the upper cap portion for retention of the sound module within the upper cap portion between a top of the upper cap portion and the retainer plate.

5. The cap of claim 4 wherein the retainer plate is removable.

6. The cap of claim 4 wherein the retainer plate is integral with the upper cap portion.

7. The cap of claim 4 wherein the retainer plate has an opening therethrough that passes light through the retainer plate to activate the sound module upon opening of the upper cap portion.

8. The cap of claim 1 wherein the auto alert is a recorded message reminder regarding dental hygeine.

9. The cap of claim 1 further comprising an adaptor sleeve configured to adapt the internally threaded connector to an outwardly treaded nozzle of a toothpaste tube.

10. A toothpaste cap comprising:
an upper cap portion connected to a bottom cap portion by a hinge region;
an auto-activated sound module associated with the upper portion; and
an enclosure cavity within the bottom portion, the enclosure cavity enclosing a removable floss spool.

11. The cap of claim 10 having a floss cutter mounted on an external face of the bottom portion and a floss dispenser opening passing through a side of the bottom portion.

12. The cap of claim 11 wherein the top portion has a tab that covers an angled external face of the bottom cap portion, the floss dispensing opening and the floss cutter in a closed position.

13. The cap of claim 10 further comprising a retention plate below the sound module within the upper cap portion for retaining the sound module within the upper cap portion.

14. The cap of claim 10 further comprising a cover portion that slides over the upper cap portion creating an enclosure for the sound module enclosure between an upper surface of the upper cap portion and the cover portion.

15. The cap of claim 10 wherein the removable floss spool is held within the enclosure cavity between an inner upper surface of the enclosure cavity and a toothpaste tube.

16. The cap of claim 10 wherein the cap is reversibly connectable to a toothpaste tube by an internally threaded connector within the enclosure cavity, the internally treaded connector being threadably attachable to an outwardly threaded nozzle of the toothpaste tube.

17. The cap of claim 10 wherein sound module is auto-activated to play a reminder one or more reminders regarding dental hygiene.

18. A toothpaste cap device comprising:
an internal cavity within an upper cap portion;
a light activated sound module within the internal cavity, the sound module comprising an audio alert
a retainer plate below the sound module within the internal cavity; and
a bottom cap portion connected to the top cap portion by a hinge region, the bottom cap portion being configured to attach the cap device to a toothpaste container.

19. The cap device of claim 17 wherein the sound module is activated by a member of the group consisting of light, vibration, sound, push button and slide mechanism.

20. The cap device of claim 18 wherein the bottom portion comprises a floss spool.

21. The cap of claim 20 wherein floss from the floss spool is dispensed through a sidewall of the bottom cap portion and wherein toothpaste is dispensed through a nozzle comprised by the bottom cap portion.

22. The cap of claim 18 wherein the sound module plays a pre-recorded reminder regarding dental hygiene.

23. A method of delivering a an auto alert, comprising providing an auto-activated sound module within a toothpaste cap device, the device being activated by auto-stimulation of the device to play one or more audio alerts selected from the group consisting of reminder regarding oral hygiene, music, alert sounds, gag messages, custom messages and combinations thereof.

24. The method of claim 23 wherein the audio alert is a pre-recorded message regarding oral hygiene with respect to flossing, brushing frequency, brushing all surfaces and brushing duration.

25. The method of claim 23 wherein sound module is auto-activated by exposure to light.
